(19) United States
(12) Patent Application Publication
(10) Pub. No.: US 2010/0169227 A1
(43) Pub. Date: Jul. 1, 2010

(54) ENERGY MANAGEMENT AND QUALITY OF SERVICE (QoS)

(75) Inventors: Gregory J. Boss, Saginaw, MI (US); James R. Doran, New Milford, CT (US); Rick A. Hamilton, II, Charlotesville, VA (US); Anne R. Sand, Peyton, CO (US)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/347,009

(22) Filed: Dec. 31, 2008

(51) Int. Cl. G06F 1/30; G06F 1/28; G06Q 10/00; G06Q 20/00; G06F 1/32

(52) U.S. Cl. 705/80; 700/295; 705/7

(57) ABSTRACT

Under the present invention, users are provided with the capability to select how energy will be throttled in shortage conditions. For example, users can promise to throttle or cut energy to devices that they consider noncritical (e.g. television, toaster, stereo) in exchange for a promise that the energy company will continue to give them enough to run more essential devices (e.g. lights, well pump, etc.). As users agree to lower usage in response to a energy shortage, they are provided a higher QoS rating than users who do not offer to lower usage. As a shortage worsens, conserving users will be allocated energy before non-conserving users. Enforcement and fulfillment of obligations established in agreements may be automated to ensure compliance.

### CROSS-REFERENCE TO RELATED APPLICATIONS

The present application is related in some aspects to commonly owned and co-pending application entitled “Framework for Managing Consumption of Energy”, assigned attorney docket no. END920070426US1, which was filed on Nov. 22, 2008, and was assigned application Ser. No. 12/208,422, the entire contents of which are hereby incorporated by reference. The present application is also related in some aspects to commonly owned and co-pending application entitled “Policy-Based Energy Management”, assigned attorney docket no. END920070427US1, which was filed on Nov. 22, 2008, and was assigned application Ser. No. 12/208,510, the entire contents of which are hereby incorporated by reference.

### FIELD OF THE INVENTION

This invention includes methods for providing variable energy pricing for objects (e.g., devices) of a system in shortage conditions. This responds to customer price sensitivity by considering the maximum threshold a consumer will bid for energy to a given device during a situation when less than adequate supply exists for demand.

### BACKGROUND OF THE INVENTION

Currently consumers are charged the same rate for their energy usage, irrespective if they conserve or not, if there is a shortage or not, etc. Current energy systems are very limited in their ability to handle shortage situations. Given the threat of terrorist attacks, natural disasters, brownouts, blackouts and supply/demand imbalances, better systems are needed. Consumers give very little thought to non-critical devices or groups of devices that could be throttled down or managed if needed.

### SUMMARY OF THE INVENTION

Under the present invention, users are provided with the capability to select how energy will be throttled in shortage conditions. For example, users can promise to throttle or cut energy to devices that they consider noncritical (e.g. television, toaster, stereo) in exchange for a promise that the energy company will continue to give them enough to run more essential devices (e.g. lights, well pump, etc.). As users agree to lower usage in response to a energy shortage, they are provided a higher QoS rating than users who do not offer to lower usage. As a shortage worsens, conserving users will be allocated energy before non-conserving users. Enforcement and fulfillment of obligations established in agreements may be automated to ensure compliance.

A first aspect of the present invention provides a method for managing energy consumption and quality of service (QoS), comprising: determining an energy throttle plan in exchange for a given QoS; detecting an energy shortage condition; throttling energy usage according to the energy throttling plan; providing the given QoS in response to the throttling; and monitoring the energy usage to ensure compliance with energy throttling plan.

A second aspect of the present invention provides a system for managing energy consumption and quality of service (QoS), comprising: a module for determining an energy throttle plan in exchange for a given QoS; a module for detecting an energy shortage condition; a module for throttling energy usage according to the energy throttling plan; a module for providing the given QoS in response to the throttling; and a module for monitoring the energy usage to ensure compliance with energy throttling plan.

A third aspect of the present invention provides a computer readable medium containing a program product for managing energy consumption and quality of service (QoS), the computer readable medium comprising instructions for enabling a computer system to perform the following: determining an energy throttle plan in exchange for a given QoS; detecting an energy shortage condition; throttling energy usage according to the energy throttling plan; providing the given QoS in response to the throttling; and monitoring the energy usage to ensure compliance with energy throttling plan.

A fourth aspect of the present invention provides a method for deploying an application for managing energy consumption and quality of service (QoS), comprising: providing a computer infrastructure being operable to: determine an energy throttle plan in exchange for a given QoS; detect an energy shortage condition; throttle energy usage according to the energy throttling plan; provide the given QoS in response to the throttling; and monitor the energy usage to ensure compliance with energy throttling plan.

A fifth aspect of the present invention provides a computer-implemented business method for managing energy consumption and quality of service (QoS), comprising: determining an energy throttle plan in exchange for a given QoS; detecting an energy shortage condition; throttling energy usage according to the energy throttling plan; providing the given QoS in response to the throttling; and monitoring the energy usage to ensure compliance with energy throttling plan.

A sixth aspect of the present invention provides a data processing system for managing energy consumption and quality of service (QoS), comprising a memory medium containing instructions, a bus coupled to the memory medium, and a processor coupled to the bus that when executing the instructions cases the data processing system to: determine an energy throttle plan in exchange for a given QoS; detect an energy shortage condition; throttle energy usage according to the energy throttling plan; provide the given QoS in response to the throttling; and monitor the energy usage to ensure compliance with energy throttling plan.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative energy management hierarchy according to the present invention.

FIG. 2 depicts an interface to heterogeneous objects according to the present invention.

FIG. 3 depicts a method flow diagram according to the present invention.

FIG. 4 depicts a more specific computerized implementation according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:

I. General Description

II. Computerized Implementation

### I. General Description

As used herein, the following terms have the associated meanings:

“Set”—a quantity of at least one.

“Object”—any device, group of devices, or organization using devices that consume energy.

Under the present invention, users are provided with the capability to select how energy will be throttled in shortage conditions. For example, users can promise to throttle or cut energy to devices that they consider noncritical (e.g. television, toaster, stereo) in exchange for a promise that the energy company will continue to give them enough to run more essential devices (e.g. lights, well pump, etc.). As users agree to lower usage in response to a energy shortage, they are provided a higher QoS rating than users who do not offer to lower usage. As a shortage worsens, conserving users will be allocated energy before non-conserving users. Enforcement and fulfillment of obligations established in agreements may be automated to ensure compliance.

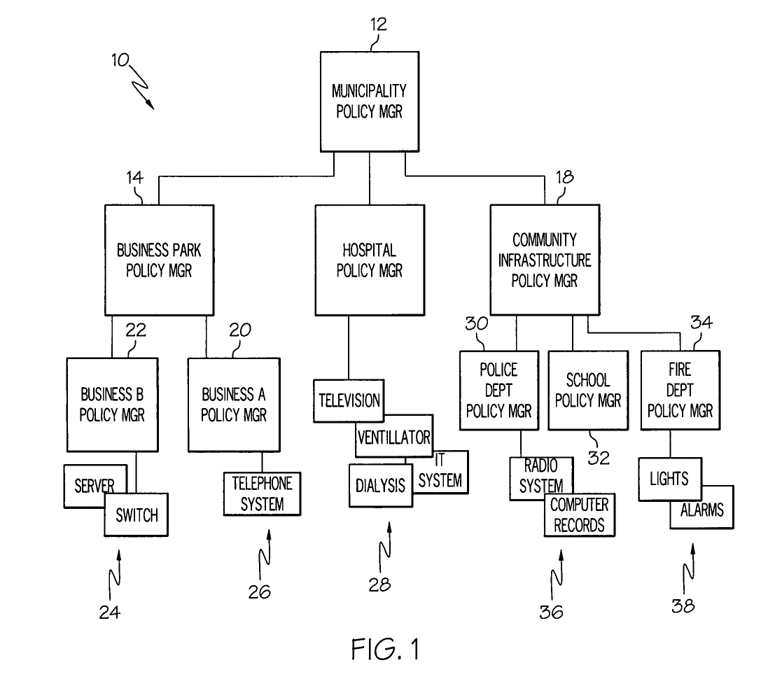

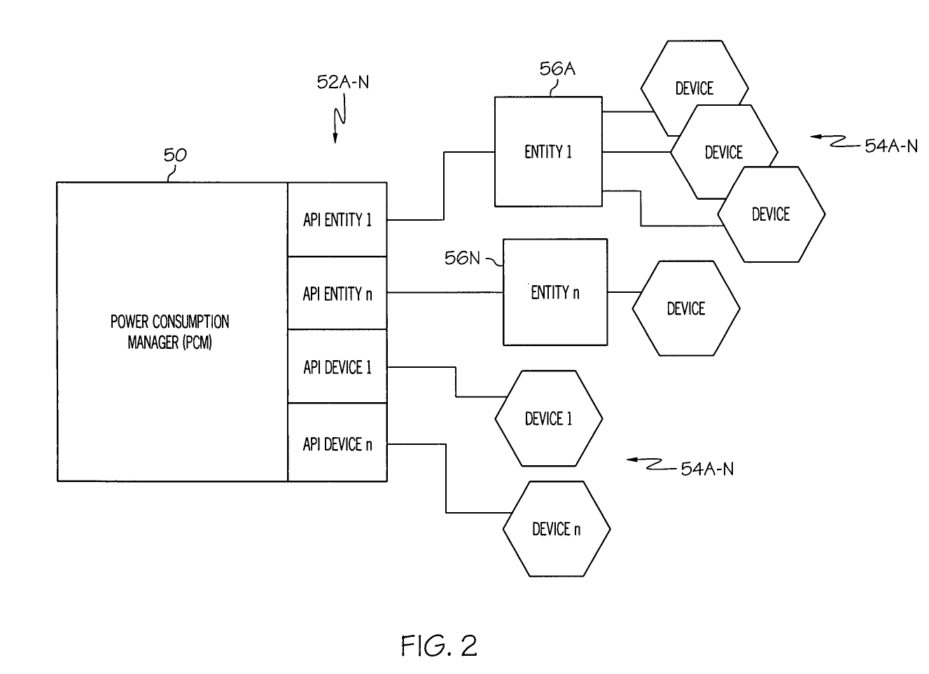

This technology can leverage the framework hierarchy, energy control manager, policy control manager, GUI, as described in the above-incorporated patent applications. For clarity, corresponding description of some of such elements is given in conjunction with FIGS. 1-2. Referring now to FIG. 1 a framework hierarchy 10 is shown. FIG. 1 is to demonstrate, among other things, that the present invention could be implemented in conjunction with any hierarchy of devices, regardless of complexity. In the example shown, energy control management systems/energy control manager (hereinafter ECM) are utilized on multiple levels. Municipality ECM 12 works in conjunction with business park ECM 14, hospital ECM 16, and community infrastructure ECM 18. Further, business park ECM 14 interacts with business A ECM 20 and business B ECM 22, each of which controls energy consumption with their own devices 24 and 26. Similarly, hospital ECM 16 controls energy consumption by devices 28. Community infrastructure ECM 18 is shown interacting with police department ECM 30, school ECM 32, and fire department ECM 34, which among themselves, manage devices 36 and 38. As can be seen, a ECM under the present invention can not only interact with devices, but also with other ECMs.

Referring now to FIG. 2, the functions of a ECM 50 will be described. As used in FIG. 2, entities 56A-n represents any business object that has one or more component/device. Sample entities may include a hospital, business or municipality. As such, devices 54A-N are each a piece of the overall system who's energy may be modulated. This may be a particular software application, piece of IT hardware (server, storage, networking switch, etc. . . . ), other hardware (life support equipment, refrigerator, etc.).

Under the present invention, each device, entity, etc. is enrolled into the system. This may occur manually, through auto-discovery by ECM 50 or by device 54A-N self-enrollment to ECM 50. Once enrolled, ECM 50 maintains a database of devices and their meta data. Sample device meta data are as follows:

Device ID=0487

Device name=“refrigeratorol”

Average energy consumed=50

Modulate capabilities=“on/off”

Quiesce first=“no”

Regardless, this functionality may be implemented with a single energy management server, groups of servers, or a hierarchy of servers. A hierarchy is the preferred embodiment for an enterprise system, as that allows for delegation to sub-entities.

As further depicted, ECM 50 has a set of application programming interfaces (APIs) 52A-N which allow communication to occur between ECM 50 and devices 54A-N and/or entities 56A-N. Although not shown in FIG. 2, an API would also allow ECM 50 to interface with another ECM. Heterogeneous devices from different vendors may have very different interfaces. The technology described herein will interface to different devices, or to any known or future energy management standard. For example, the interface to communicate with IBM WebSphere XD software (WebSphere is a trademark of IBM Corp in the United States and/or other countries) may differ greatly from the interface for a medical device to manage energy to an anesthesia machine, which would differ from the interface to a refrigerator.

Under the present invention, customers preregister with the energy provider, including the following information: listing and groupings of devices; price sensitivity for each, communicated as either a maximum threshold or variable price per device(s); energy limiting capabilities and methods for each; and indicators for devices that are critical to safety or medical necessity. When an energy shortage situation occurs, the system enables consumers to request a real-time modification of their management policy to change their price sensitivity. The energy provider can then manage (e.g., throttle) energy to consumers based on preset policy and severity of shortage. Then, consumers are billed based on energy used and agreed to price based on device usage.

Any known or future methods for physically controlling energy to devices or monitoring their energy usage may be used. Regardless, the present invention typically implements the following steps:

1. Determine Throttle Factors

The amount of cutback in energy usage may be determined using many different criteria. Examples of individual customer factors to consider may include:
Number of residents
Size of home or business
Seasonality and recent weather
Medical condition of residents
   The throttle may be determined by set or variable amounts and based on customer or others, including:
Percentage of average historical use for this site (e.g. rolling 30 day average, average use for this month in prior years, etc.)
Based on other homes or businesses that are similar
To a set amount (number of kilowatts over a given time duration)
   Energy usage in a home or business may be thought of in terms of a fixed and a variable component. The fixed component keeps main systems running (well pump, refrigerator, enough heat to keep pipes from freezing, etc.). The variable component includes the energy that is more easily conserved, such as the extra few degrees of heat for comfort, extra showers for more residents, longer shower for preference, etc.

Conserving on the types of energy that fall into the variable component can more acceptable to customers. In one embodiment, amount of conservation requested may be determined as follows:
1. Determine a fixed component
2. Determine variable component
3. Ask resident to conserve a percentage of the variable component
   Energy shortages may occur at different levels of severity (slight shortage of only 5% reduced supply, critical shortage with only 50% of usual supply, etc). These agreements may be negotiated for any levels of shortage, so that appropriate amount of reduction would be required.

2. Pre-Negotiate Throttle for QoS

The customer and provider may pre-negotiate for a given QoS agreement for a set amount of throttle. As different levels of required conservation may occur, it is expected that multiple throttle levels and their associated QoS agreements will be established. The end result is that an energy throttling plan will be developed for the customer and provider.

3. Notify when Conservation is Required (Optional)

If sufficient time is available before conservation is required (e.g. a shortage in supply has occurred), it is preferable for the energy provider to notify customers of the shortage and upcoming throttle.

4. Enable Real-Time Negotiations (Optional)

The customer may wish to negotiate a new or renegotiate an existing agreement once the shortage has occurred.

5. Throttle Energy Usage

The Energy Conservation Manager sends the signal that energy is to be throttled. This may be sent to a central energy manager at a location, directly to a device, to an in-line energy controlling device, etc. This step in this invention involves the signaling only. Actual controlling of energy to a device is done by other known or future means. Regardless, throttling is done in accordance with the energy throttling plan.

In a typical embodiment, throttle is initiated and controlled automatically by user-controlled software management system. As some premises may not have such a system, once throttle instruction is sent, devices may be throttled manually (e.g. customer turns off selected devices). Moreover, the throttle may be set up to be mandatory or voluntary:
If mandatory, once Energy Conservation System initiates throttle, customer does not have control over throttle until it is complete.
If voluntary, customer may override throttle command. In this case, if agreed to level of compliance is not achieved, customer does not get promised QoS level and is at risk of losing all energy.

6. Monitor for Compliance

Throttling will be monitored to ensure user is complying with negotiated cutback. This may use any known or future methods of determining energy usage. One example of currently used technology includes a smart meter at the customer premise that records amount of kilowatts used per each time duration.

Pre-Negotiated Agreement Steps

1. Energy consumers pre-register with energy provider, agreeing to levels of conservation in exchange for QoS.

2. Situation occurs to require conservation (e.g. shortage condition or other mandate).

3. Energy providers notify users of initiation of conservation requirement.

4. Users lower consumption based on predefined agreement.

5. If shortage worsens, conserving users will be provided their agreed-to minimum amount of energy while non-conserving users will possibly lose all energy.

6. Energy usage is monitored to ensure compliance.

Real Time Agreement Steps

1. Situation occurs to require conservation (e.g. shortage condition or other mandate).

2. Energy providers notify users of initiation of conservation requirement.

3. Users negotiate with energy provider for QoS based on amount of conservation.

4. Users lower energy consumption to agreed-to level.

5. If shortage worsens, conserving users will be provided their agreed-to minimum amount of energy while non-conserving users will possibly lose all energy.

6. Energy usage is monitored to ensure compliance.

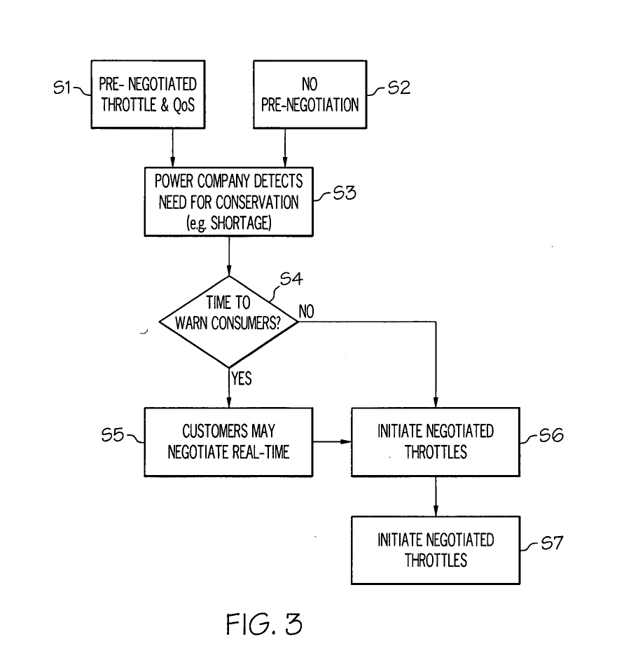

Collectively, the process is shown in FIG. 3. As depicted, in steps S1 and S2 is it determined whether an energy throttling plan is pre-negotiated. In either case, in step S3, the energy provider (Power Company) detects an energy shortage condition. In step S4, it is determined whether sufficient time is present to warn the users/customers. If so, customers may negotiate or renegotiate an energy throttling plan in real time in step S5. If there was not sufficient time to warn the users/customers, the negotiated throttles are initiated in step S6, and then monitored to ensure compliance in step S7.

### II. Computerized Implementation

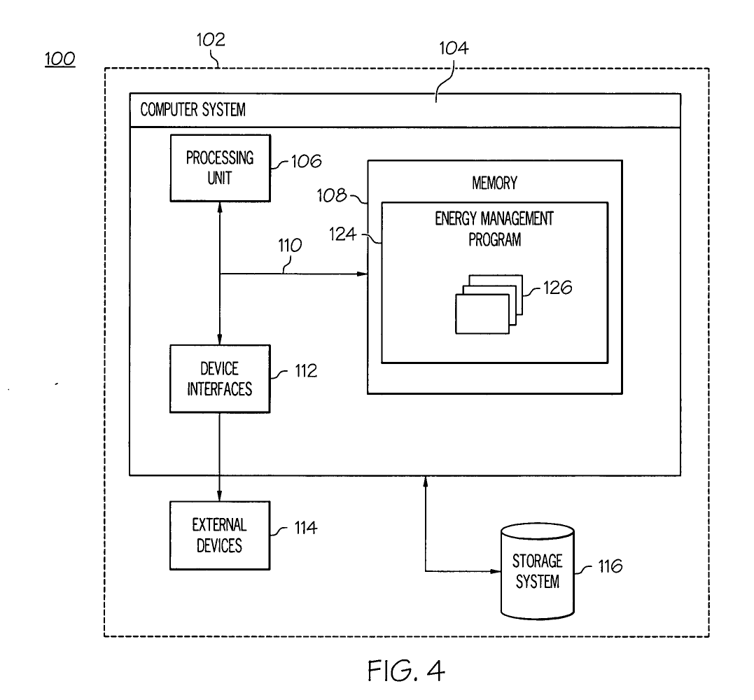

Referring now to FIG. 4, a computerized implementation 100 of the present invention is shown. As depicted, implementation 100 includes computer system/ECM 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others.

Computer system is intended to represent any type of computer system that may be implemented in deploying/realizing the teachings recited herein. In this particular example, computer system 104 represents an illustrative system that could represent a ECM. It should be understood that any other computers implemented under the present invention will have similar components, but may perform different functions/have different software. As shown, computer system 104 includes a processing unit 106, a memory 108, a bus 110, and device interfaces 112. Further, computer system 104 is shown communicating with one or more external devices 114 that communicate with bus via device interfaces. In general, processing unit 106 executes computer program code, such energy management program 124, which is stored in memory 108 and/or storage system 116. While executing computer program code, processing unit 106 can read and/or write data to/from memory 108, storage system 116, and/or device interfaces 112. Bus 110 provides a communication link between each of the components in computer system 104. Although not shown, computer system 104 could also include I/O interfaces that communicate with: one or more external devices such as a kiosk, a checkout station, a keyboard, a pointing device, a display, etc.); one or more devices that enable a user to interact with computer system 104; and/or any devices (e.g., network card, modem, etc.) that enable computer system 104 to communicate with one or more other computing devices. Although not shown, computer system 104 could contain multiple processing units.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various processes of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, device interfaces 112 can comprise any module for exchanging information with one or more external devices. Still further, it is understood that one or more additional components (e.g., system software, math co-processing unit, etc.) not shown in FIG. 4 can be included in computer system 104.

Storage system 116 can be any type of system capable of providing storage for information under the present invention. To this extent, storage system 116 could include one or more storage devices such as magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system 104.

Shown in memory 108 of computer system 104 is energy management program 124, which has a set of modules 126. Set of modules 126 generally provide the functions of the present invention as described herein.

While shown and described herein as a framework for energy management and QoS, it is understood that the invention further provides various alternative embodiments. For example, in one embodiment, the invention provides a computer-readable/useable medium that includes computer program code to enable a computer infrastructure to variable energy pricing. To this extent, the computer-readable/useable medium contains program code that implements each of the various processes of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 3) and/or storage system 116 (FIG. 3) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to provide energy management and QoS. In this case, the service provider can create, maintain, support, etc., a computer infrastructure, such as computer infrastructure 102 (FIG. 3) that performs the process of the invention for one or more customers. In return, the service provider can receive payment from the customers under a subscription and/or fee agreement and/or the service provider can receive payment from the sale of advertising content to one or more third parties.

In still another embodiment, the invention provides a computer-implemented method for energy management and QoS. In this case, a computer infrastructure, such as computer infrastructure 102 (FIG. 3), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 104 (FIG. 3), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic device system/driver for a particular computing and/or device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or device devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for managing energy consumption and quality of service (QoS), comprising:
determining an energy throttle plan in exchange for a given QoS;
detecting an energy shortage condition;
throttling energy usage according to the energy throttling plan;
providing the given QoS in response to the throttling; and
monitoring the energy usage to ensure compliance with energy throttling plan.

2. The method of claim 1, the determining comprising negotiating the energy throttling plan with a user of the energy.

3. The method of claim 2, the throttling being performed by a provider of energy in accordance with the energy throttling plan.

4. The method of claim 3, the providing of the given QoS being performed by a provider of the energy to the user

5. The method of claim 1, the monitoring being performed to ensure compliance with the energy throttling plan and the given QoS.

6. The method of claim 1, further comprising providing a notification when the energy shortage condition is detected.

7. The method of claim 1, the determining being performed in real-time.

8. A system for managing energy consumption and quality of service (QoS), comprising:
a module for determining an energy throttle plan in exchange for a given QoS;
a module for detecting an energy shortage condition;
a module for throttling energy usage according to the energy throttling plan;
a module for providing the given QoS in response to the throttling; and
a module for monitoring the energy usage to ensure compliance with energy throttling plan.

9. The system of claim 8, the energy throttling plan being a result of a negotiation with a user of the energy.

10. The system of claim 9, the throttling being performed by a provider of energy in accordance with the energy throttling plan.

11. The system of claim 10, the given QoS being performed by a provider of energy to the user

12. The system of claim 8, the module for monitoring being configured to monitor compliance with the energy throttling plan and the given QoS.

13. The system of claim 8, further comprising a module for providing a notification when the energy shortage condition is detected.

14. The system of claim 8, the module for determining being configured to perform in real-time.

15. A computer readable medium containing a program product for managing energy consumption and quality of service (QoS), the computer readable medium comprising instructions for enabling a computer system to perform the following:
determining an energy throttle plan in exchange for a given QoS;
detecting an energy shortage condition;
throttling energy usage according to the energy throttling plan;
providing the given QoS in response to the throttling; and
monitoring the energy usage to ensure compliance with energy throttling plan.

16. The computer readable medium containing the program product for managing energy consumption and quality of service (QoS) of claim 15, the computer readable medium further comprising instructions for enabling the computer system to perform the following step: negotiating the energy throttling plan with a user of the energy.

17. The computer readable medium containing the program product for managing energy consumption and quality of service (QoS) of claim 15, the monitoring being performed to ensure compliance with the energy throttling plan and the given QoS.

18. The computer readable medium containing the program product for managing energy consumption and quality of service (QoS) of claim 15, the computer readable medium further comprising instructions for enabling the computer system to perform the following step: further comprising providing a notification when the energy shortage condition is detected.

19. The computer readable medium containing the program product for managing energy consumption and quality of service (QoS) of claim 151, the determining being performed in real-time.

20. A method for deploying an application for managing energy consumption and quality of service (QoS), comprising:
determine an energy throttle plan in exchange for a given QoS;
detect an energy shortage condition;
throttle energy usage according to the energy throttling plan;
provide the given QoS in response to the throttling; and
monitor the energy usage to ensure compliance with energy throttling plan.
